(19) United States
(12) Patent Application Publication
(10) Pub. No.: US 2018/0088438 A1
(43) Pub. Date: Mar. 29, 2018

(54) DISPLAY DEVICE

(71) Applicants: BOE Technology Group Co., Ltd., Beijing (CN); BEIJING BOE OPTOELECTRONICS TECHNOLOGY CO., LTD., Beijing (CN)

(72) Inventors: Qian Wang, Beijing (CN); Xiaochuan Chen, Beijing (CN); Wenqing Zhao, Beijing (CN); Rui Xu, Beijing (CN); Lei Wang, Beijing (CN); Ming Yang, Beijing (CN); Pengcheng Lu, Beijing (CN); Jian Gao, Beijing (CN); Xiaochen Niu, Beijing (CN)

(21) Appl. No.: 15/521,935

(22) PCT Filed: Jun. 3, 2016
(86) PCT No.: PCT/CN2016/084697

§ 371 Date: Apr. 26, 2017

(30) Foreign Application Priority Data
Mar. 11, 2016 (CN) 201610140482.X

(51) Int. Cl. G02F 1/29

(52) U.S. Cl. CPC G02F 1/292

(57) ABSTRACT

A display device, including a backlight module and a display module which is located at a light exiting side of the backlight module, the display device further includes a grating selector which is located between the backlight module and the display module and an optical modulation unit which is located at the light exiting side of the display module. The display module includes: a pixel array including a plurality of pixels, each pixel has a plurality of blocks; and a grating microstructure configured to control each block of the pixel to exit light in different directions. The grating selector is configured to control light emitted from the backlight module to illuminate on a corresponding block of the pixel, so that the light can exiting from the pixel in a particular direction. The optical modulation unit is configured to modulate the light exiting from the pixel in the particular direction.

### CROSS-REFERENCE TO RELATED APPLICATIONS

The present application is based on International Application No. PCT/CN2016/084697, filed on Jun. 3, 2016, which is based upon and claims priority to Chinese Patent Application No. 201610140482.X, filed on Mar. 11, 2016, and the entire contents thereof are incorporated herein by reference.

### TECHNICAL FIELD

The present disclosure relates to the technical field of display, and more particularly to a display device.

### BACKGROUND

With the development of display manufacturing technology, liquid crystal display technology is developing rapidly, the liquid crystal display has gradually replaced a traditional CRT monitor and become the mainstream of future flat panel displays. In the technology field of the liquid crystal display, a Thin Film Transistor Liquid Crystal Display (TFT-LCD) is widely used in TV sets, computers, mobile phones and so on, as it has advantages of a large size, high integration, powerful functions, a flexible production process and a low cost.

Generally, a display device comprises a backlight module and a display module. The display module is formed by cell assembling an array substrate (i.e., a TFT substrate) and a color film substrate (i.e., a CF substrate) and filling liquid crystal molecules between the array substrate and the color film substrate. Wherein, the backlight module is configured to provide a backlight to the display module for display. However, inventors of the present disclosure have discovered that the light emitted from the backlight module is divergent, that is, the light is emitted in a plurality of directions, thus, if a viewer is watching images displayed, in all of the directions facing the light exiting side of the display device, he or she can see the images displayed. However, for the contents that are private and not desired to be seen by others, the confidentiality of such a display device has its limitations. Therefore, a display device in which the light exiting direction is adjustable is particularly important.

It should be noted that, information disclosed in the above background portion is provided only for better understanding of the background of the present disclosure, and thus it may contain information that does not form the prior art known by those ordinary skilled in the art.

### SUMMARY

In view of the problem existing in the related device play, the present disclosure provides a device display, in which the light exiting direction of is adjustable.

Embodiments of the present disclosure provide a display device comprising a backlight module and a display module which is located at a light exiting side of the backlight module, wherein, the display device further comprises a grating selector which is located between the backlight module and the display module and an optical modulation unit which is located at the light exiting side of the display module, wherein,

the display module comprises: a pixel array comprising a plurality of pixels, each pixel has a plurality of blocks; and a grating microstructure, which is configured to control each of the blocks of the pixel to emit light in different directions;

the grating selector is configured to control light emitted from the backlight module to illuminate on a corresponding block of the pixel, so that the light can exiting from the pixel in a particular direction; and

the optical modulation unit is configured to modulate the light exiting from the pixel in the particular direction, so that an image displayed on the display device can be visible at a particular angle.

The display device may further comprise a human eye positioning unit and a control unit; wherein, the human eye positioning unit is configured to position a position of a user's eye and send a position information to the control unit; and the control unit is configured to control the grating selector to operate according to the position information.

### BRIEF DESCRIPTION OF THE DRAWINGS

FIG. 1 is a view showing the structure of a display device provided by an embodiment of the present invention;

FIG. 2 is a view showing a pixel of a display device provided by an embodiment of the present invention;

FIG. 3 is a view showing a grating microstructure of a display device provided by an embodiment of the present invention;

FIG. 4 is a view showing a grating selector of a display device provided by an embodiment of the present invention;

FIG. 5 is a view showing an optical modulation unit of a display device provided by an embodiment of the present invention;

FIG. 6 is a view showing a visible image displayed on a display device provided by an embodiment of the present invention; and

FIG. 7 is a view showing the case of anti-peeping an image displayed on a display device provided by an embodiment of the present invention.

### DETAILED DESCRIPTION

In order that those skilled in the art will better understand the technical solutions of the present disclosure, the present disclosure will be described in further detail with reference to the accompanying drawings and detailed description.

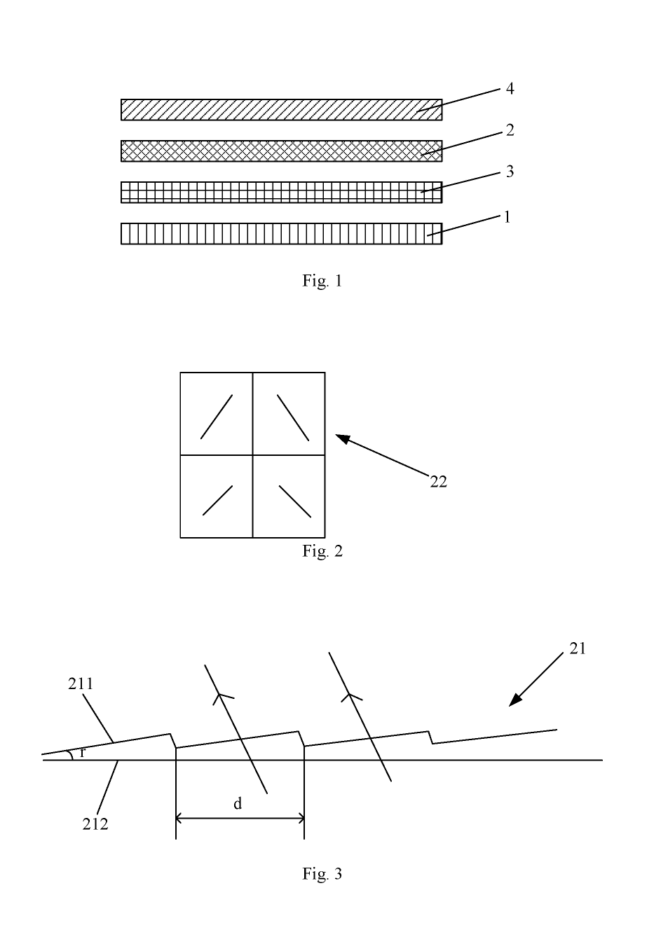

As shown in FIG. 1, an embodiment of the present disclosure provides a display device. The display device comprises: a backlight module 1; a display module 2, which is located at the light exiting side of the backlight module 1; a grating selector 3, which is located between the backlight module 1 and the display module 2; and an optical modulation unit 4, which is located at the light exiting side of the display module 2. Referring to FIGS. 2 and 3, the display module 2 comprises: a pixel array comprising: a plurality of pixels 22, each pixel 22 having a plurality of blocks; and a grating microstructure 21, which is configured to control each of the blocks of the pixel 22 to emit light in different directions. The grating selector 3 is configured to control light emitted from the backlight module 1 to illuminate on a corresponding block of the pixel 22, so that the light can be emitted from the pixel 22 in a particular direction. The optical modulation unit 4 is configured to modulate the light in a particular direction exiting from the pixel 22, so that an image displayed on the display device can be visible at a particular angle.

According to the display device of the present embodiment, the grating microstructure 21 is used together with the pixel 22, each pixel 22 has a plurality of blocks, and the grating microstructure 21 can perform control, so that direction of the light exiting from each of the blocks of each pixel 22 is different from one another. For example, each pixel 22 has four blocks, the blocks can be controlled by the grating microstructure 21 so that the direction of the light exiting from each of the four blocks of the pixel 22 is different from one another. That is, each pixel 22 can result in four light exiting directions. Then, the grating selector 3 is used so that the light corresponding to one of the blocks and emitted by the backlight module 1 is transmitted through the grating selector 3. That is, each pixel 22 is controlled to emit light in a particular direction by the grating selector 3. Finally, the light in the particular direction transmitted from each pixel 22 is modulated by the optical modulation unit 4 to obtain light in a desired direction, so that an image displayed on the display device is visible at a particular angle.

Specially, as shown in FIG. 2, each pixel 22 can be divided into a plurality of blocks (e.g., four blocks shown in the figure). As shown in FIG. 3, the grating microstructure 21 is preferably a blazed grating, which is formed by combining grating surfaces 212 and grooves 211. When an incident direction of light is perpendicular to the grooves 211 and satisfies 2d*sin r=λ (d is the width of each of the grating surfaces 212, r is the angle between each of the grating surfaces 212 and a corresponding groove 211, and X is the wavelength of the incident light), a beam of light with the wavelength will be blazed and strengthened to exit in a particular direction. By designing d and r with different values, different light exiting angles and different exiting wavelength bands can be obtained. The blazing grating has the function of selecting the incident light, and the exiting light is a set of parallel beams perpendicular to the grooves 211. According to the present embodiment, for example, each pixel 22 is divided into four blocks, and the value of r of the blazed grating corresponding to each block can be adjusted so that the four blocks correspond to different light exiting directions.

In the present embodiment, the blazed grating may be attached to the substrate of the pixel array and may be provided on the light incident side of the pixel array or may be provided on the light exiting side of the pixel array. Of course, the blazed grating may be integrated with the pixel 22 on the display module 2 to form one component. For example, the blazed grating may be formed at a same step with the dielectric layer on the light exiting side of the color film layer of the pixel 22 or the dielectric layer on the light incident side of the color film layer of the pixel 22, or may be formed at a same step with an insulating layer on the array substrate of the pixel 22, and just to name a few.

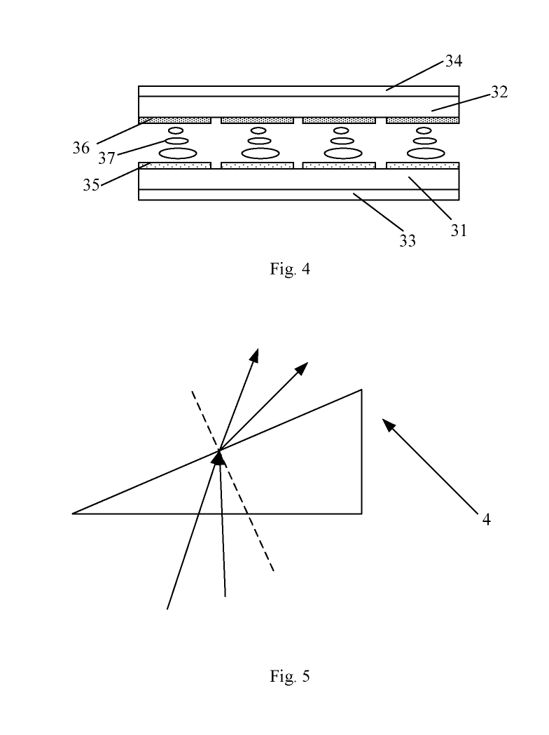

Specially, as shown in FIG. 4, in the present embodiment, the grating selector 3 comprises: a liquid crystal cell; a lower polarizer 33, which is provided on the light incident side of the liquid crystal cell; and an upper polarizer 34, which is provided on the light exiting side of the liquid crystal cell; wherein, the polarizing direction of the upper polarizer 34 is perpendicular to the polarizing direction of the lower polarizer 33. Whether the light emitted from the backlight module 1 can be transmitted through the upper polarizer 34 is controlled by an internal electrode of the liquid crystal cell. Wherein, the liquid crystal cell is any one of a TN mode, an ADS mode, a FFS mode and an IPS mode.

The TN (Twisted Nematic) mode (vertical electric field): in this mode, a plurality of first electrodes 35 are provided on a first substrate 31 of the liquid crystal cell, and a plurality of second electrodes 36 are provided on a second substrate 32 of the liquid crystal cell. Each of the first electrodes 35 is disposed opposite to a corresponding second electrode correspond 36, and one of the first electrodes 35 and a corresponding second electrode 36 correspond to one of the blocks in the pixel 22, and the first electrodes 35 and the second electrodes 36 are plate-like electrodes. Since polarizing direction of the upper polarizer 34 is perpendicular to the polarizing direction of the lower polarizer 33, when different voltages are applied on the first electrode 35 and the second electrode 36 corresponding to a certain block in the pixels 22, liquid crystal molecules 37 corresponding to this block are deflected, and the light emitted from the backlight module 1 can be transmitted through position corresponding to this block to illuminate on the pixel 22, so that light can exiting from the pixel 22 in a particular direction. And the first electrodes 35 and the second electrodes 36 at other positions are not applied with a voltage (or applied with the same voltage), the liquid crystal molecules 37 at other positions do not deflect, so that no light is transmitted through other positions, thus the control to the light exiting directions of the pixel 22 can be achieved.

The ADS (Advanced Super Dimension Switch) mode: in this mode, a plurality of first electrodes 35 and a plurality of second electrodes 36 are sequentially provided on a first substrate 31 of the liquid crystal cell. Each of the first electrodes 35 is disposed opposite to a corresponding second electrodes 36, one of the first electrodes 35 and a corresponding second electrode 36 correspond to one of the blocks in the pixel 22, and the first electrodes 35 are plate-like electrodes and the second electrodes 36 are stripe-like electrodes. Since the polarizing direction of the upper polarizer 34 is perpendicular to the polarizing direction of the lower polarizer 33, when different voltages are applied on the first electrode 35 and the second electrode 36 corresponding to a certain block in the pixels 22, liquid crystal molecules 37 corresponding to this block are deflected, and the light emitted from the backlight module 1 can be transmitted through positions corresponding to this block to illuminate on the pixel 22, so that light can exiting from the pixel 22 in a particular direction. And the first electrodes 35 and the second electrodes 36 at other positions are not applied with a voltage (or applied with the same voltage), the liquid crystal molecules 37 at other positions do not deflect, so that no light is transmitted through other positions, thus the control to the light exiting directions of the pixel 22 can be achieved.

The FFS (Fringe Field switching) mode (transverse electric field): in this mode, a plurality of first electrodes 35 and a plurality of second electrodes 36 are sequentially provided on the first substrate 31 of the liquid crystal cell, and each of the first electrodes 35 and each of the second electrodes 36 are disposed alternately, one of the first electrodes 35 and one of the second electrodes 36 correspond to one of the blocks in one pixel 22, the first electrode 35 and the second electrode 36 are strip-like electrodes, and the operation principle of the mode is similar to the above mentioned principle, the description is not repeated.

The IPS (In Plane Switching) mode: In this mode, a plurality of first electrodes 35 and a plurality of second electrodes 36 are alternately provided on the first substrate 31 of the liquid crystal cell, one of the first electrodes 35 and an adjacent second electrode 36 correspond to one of the blocks 22 in one pixel 22, the first electrode 35 and the second electrode 36 are strip-like electrodes, and the operation principle of the mode is similar to the above mentioned principle, and the description is not repeated.

As shown in FIG. 5, the optical modulating unit 4 in the present embodiment may be a liquid crystal lens, the shape of the liquid crystal lens can be adjusted by controlling the magnitude of the voltage applied to an electrode of the liquid crystal lens. And the direction of the parallel light beams emitted from the pixels array together with the grating microstructure 21 is modulated, thus the controllability of the light exiting direction in the display device can be achieved.

Optionally, the display device in the present embodiment further comprises a human eye positioning unit and a control unit, the human eye positioning unit is configured to position the position of the user's eye and send the position information to the control unit; the control unit is used to control the grating selector 3 to operate according to the position information.

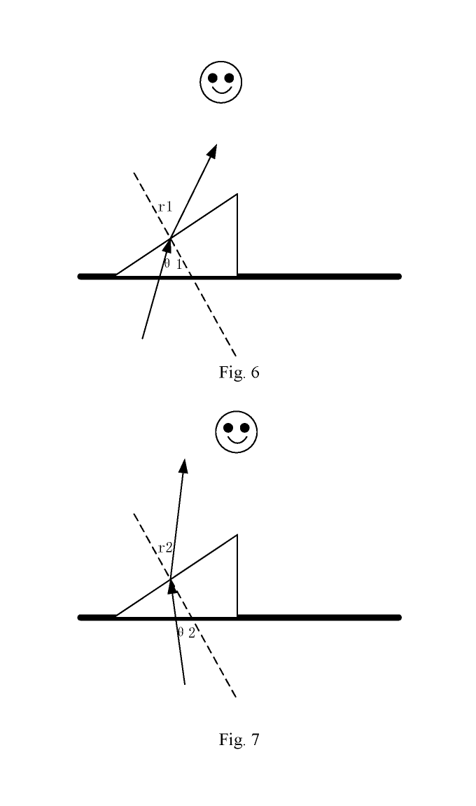

Specifically, the position of the human eye is positioned by the human eye positioning unit, then the position information is obtained and sent to the control unit, at this time, the control unit controls the grating selector 3 to selectively open a corresponding block in the pixel 22 so that the light exiting from the grating microstructure 21 corresponding to the block enters the optical modulating unit 4. As shown in FIG. 6, when the incident angle of the light entering the optical modulation unit 4 is θ1, the exiting angle of the light is r1 after it passes through the optical modulation unit 4, then the light enters into the human eye, thus the human eye can receive image information displayed on the display device. To achieve an anti-peeping display, the control unit controls the grating selector 3 to selectively open another block in the pixel 22 so that the light exiting from the grating microstructure 21 corresponding to the block enters the optical modulating unit 4. As shown in FIG. 7, when the incident angle of the light entering the optical modulation unit 4 is θ2, the exiting angle of the light is r2 after it passes through the optical modulation unit 4, then the light cannot enter into the human eye, thus the human eye can not receive the image information displayed on the display device, that is, the anti-peeping display is achieved. Wherein, the human eye positioning unit may be an infrared tracking locator, or other instruments with the same function.

As described above, the display device in the present embodiment can adjust the light exiting direction of the display device according to the human eye position, that is, the image information displayed on the display device can be seen at a particular viewing angle, and when a private content is displayed, the exiting direction of the light can be adjusted, so that the content displayed is kept confidential.

Of course, it should be noted here that the backlight module 1 of the display device of the present embodiment may be a direct type backlight module or a side type backlight module, and is not specially limited thereto.

The display device of the present embodiment may be any product or component having a display function such as a liquid crystal panel, an OLED panel, an electronic paper, a mobile phone, a tablet computer, a television set, a monitor, a notebook computer, a digital photo frame, or a navigator.

It is to be understood that the above embodiments are merely exemplary embodiments employed for the purpose of illustrating the principles of the present disclosure, but the present disclosure is not limited thereto. It will be apparent to those skilled in the art that various changes and modifications can be made therein without departing from the spirit and spirit of the present disclosure, and such changes and modifications are also regarded to be within the scope of the present disclosure.

1. A display device, comprising
a backlight module,
a display module, located at a light exiting side of the backlight module,
a grating selector, located between the backlight module and the display module, and
an optical modulation unit, located at the light exiting side of the display module,
the display module comprises:
a pixel array comprising a plurality of pixels, each pixel having a plurality of blocks; and
a grating microstructure, configured to control each of the blocks of each pixel to emit light in different directions;
the grating selector is configured to control light emitted from the backlight module to illuminate on a corresponding block of the pixel, so that the light exits from the pixel in a particular direction; and
the optical modulation unit is configured to modulate the light exiting from the pixel in the particular direction, so that the image displayed on the display device is visible at a particular angle.

2. The display device of claim 1, wherein, the grating selector comprises:
a liquid crystal cell;
a lower polarizer, disposed on a light incident side of the liquid crystal cell; and
an upper polarizer, disposed on a light exiting side of the liquid crystal cell;
wherein a polarizing direction of the upper polarizer is perpendicular to a polarizing direction of the lower polarizer, and an internal electrode of the liquid crystal cell is configured to control whether the light emitted from the backlight module is transmitted through the upper polarizer.

3. The display device of claim 2, wherein, the liquid crystal cell is any one of a TN mode, an ADS mode, a FFS mode and an IPS mode.

4. The display device of claim 1, wherein, the grating microstructure is a blazing grating.

5. The display device of claim 4, wherein, the blazed grating is attached to a substrate of the pixel array.

6. The display device of claim 4, wherein, the blazed grating is integrated with the pixels on the display module to form one component.

7. The display device of claim 1, wherein, the optical modulating unit is a liquid crystal lens.

8. The display device of claim 1 further comprising a human eye positioning unit and a control unit; wherein,
the human eye positioning unit is configured to position a position of a user's eye and send position information to the control unit; and
the control unit is configured to control the grating selector to operate according to the position information.

9. The display device of claim 8, wherein, the human eye positioning unit is an infrared tracking locator.

10. The display device of claim 1, wherein, the backlight module is a direct type backlight module or a side type backlight module.
